(19) United States
(12) Patent Application Publication
(10) Pub. No.: US 2020/0193961 A1
(43) Pub. Date: Jun. 18, 2020

(54) SYSTEM FOR SYNCHRONIZING SPEECH AND MOTION OF CHARACTER

(71) Applicant: Artificial Intelligence Research Institute, Seongnam-si (KR)

(72) Inventor: Dae Seoung KIM, Seoul (KR)

(73) Assignee: Artificial Intelligence Research Institute, Seongnam-si (KR)

(21) Appl. No.: 16/234,462

(22) Filed: Dec. 27, 2018

(30) Foreign Application Priority Data
Dec. 17, 2018 (KR) 10-2018-0162733

(51) Int. Cl. G10L 13/033; G10L 13/08; G06T 13/20; G06T 13/80

(52) U.S. Cl. CPC G10L 13/033; G06T 13/80; G06T 13/205; G10L 13/08

(57) ABSTRACT

Provided is a system for synchronizing a speech and a motion of a character, which, from an utterance sentence that is input, generates motion information of a character and execution time information of a motion corresponding to reproduction time information of a speech and the utterance sentence, generates execution time information of the motion that is modified on the basis of the generated reproduction time information of the speech and the generated execution time information of the motion and reduction time information of the speech that is modified through synchronization with the modified execution time information of the motion, and generates and reproduces an image and a speech for executing the motion of the character according to the modified time information.

### CROSS-REFERENCE TO RELATED APPLICATION

This application claims priority to and the benefit of Korean Patent Application No. 10-2018-0162733, filed on Dec. 17, 2018, the disclosure of which is incorporated herein by reference in its entirety.

### BACKGROUND

### 1. Field of the Invention

The present invention relates to a system for synchronizing speech and a motion of a character, and more specifically, to a system for outputting an image and a speech by generating a motion of a character corresponding to an input sentence and synchronizing an utterance of the character with the motion of the character on the basis of the motion of the character.

### 2. Discussion of Related Art

In event halls and the like, virtual characters using two-dimensional (2D) or three-dimensional (3D) animation are used as virtual guides who introduce main contents of the event and the event hall. Also, in banks, marts, and the like, virtual characters are used to introduce products or answer customers' questions, expanding the range of applications.

There is also emergence of a technology in which a virtual character acquires intelligence through artificial neural network-based learning and identifies an emotion and the like from a context of a given sentence and expresses a speech, a facial expression, or a motion corresponding thereto.

A large number of techniques have been developed to generate plausible shapes of a mouth, facial expressions, and motions of a virtual character when the virtual character outputs a speech. However, according to the conventional techniques, a sound is synthesized first and a motion of a character is controlled in synchronization with an output of the sound, and thus synthesizing a speech and a motion of the character frequently leads to the character seeming unnatural.

### SUMMARY OF THE INVENTION

The present invention is directed to providing a system in which, in order to synchronize a speech and a character motion generated from an utterance sentence on the basis of a time required for executing the character motion, the speech is modified so that plausible speech and character motion are output.

The present invention is directed to providing a system in which various modifications for synchronizing a speech and a character motion generated from an utterance sentence are supported to output variously expressed speeches and character motions depending on situations.

The technical objectives of the present invention are not limited to the above, and other objectives may become apparent to those of ordinary skill in the art based on the following descriptions.

According to an aspect of the present invention, there is provided a system for synchronizing a speech and a motion of a character including a speech engine unit, a motion engine unit, a control unit, a motion executing unit, and a speech output unit.

The speech engine unit generates reproduction time information of a speech from an utterance sentence that is input.

The character motion engine unit generates motion information of a character corresponding to the utterance sentence and execution time information of a motion from the utterance sentence that is input.

The generated reproduction time information of the speech and the generated execution time information of the motion are transmitted to the control unit, and the control unit generates execution time information of the motion that is modified on the basis of the utterance sentence and the time information regarding the speech and the motion and generates reproduction time information of the speech that is modified through synchronization with the modified execution time information of the motion.

The motion executing unit generates an image in which the motion of the character is executed according to the motion information of the character and the modified execution time information of the motion that are provided by the control unit and reproduce the generated image.

The speech output unit generates a speech according to the modified reproduction time information of the speech that is provided by the control unit and reproduces the generated speech.

Utterance type information may be further input to the speech engine unit and the character motion engine unit. In this case, the utterance type information may include at least one of: emphasis information indicating a part to be emphasized in the utterance sentence and an extent of the emphasis; stress information of a syllable; and length information of the syllable, and the speech engine unit may generate the reproduction time information of the speech from the utterance sentence using the utterance type information, and the character motion engine unit may generate the motion information of the character corresponding to the utterance sentence and the execution time information of the motion from the utterance sentence using the utterance type information.

The character motion engine unit may generate a plurality of pieces of character motion information corresponding to one of a syntactic word, a space between syntactic words, or a word included in the utterance sentence and execution time information of each motion.

The speech engine unit may generate and transmit a speech corresponding to the utterance sentence, and, in this case, the speech output unit may modify the speech, which is generated by the speech engine unit, according to the modified reproduction time information of the speech that is provided by the control unit and reproduce the modified speech.

The character motion engine unit may generate and transmit operation information of a character skeleton for executing the motion of the character according to the generated motion information of the character and the modified execution time information of the motion and, in this case, the motion executing unit may modify the operation information of the character skeleton, which is generated by the character motion engine unit according to the motion information of the character and the modified execution time information of the motion that are provided by the control unit, to generate an image in which the motion of the character is executed.

The control unit may modify the reproduction time information of the speech by modifying a pronunciation time of a syllable (lengthening or shortening of the pronunciation time) or modifying an interval between syllables (increasing or decreasing of the interval).

The execution time information of the motion generated by the character motion engine unit may include a minimum execution time and a maximum execution time of the motion, and the control unit may modify the execution time information of the motion by determining an execution time of the motion according to the reproduction time information of the speech within a range of the minimum execution time to the maximum execution time of the motion.

The system may further include a synthesizing unit.

The synthesizing unit may generate a character animation by synthesizing the image output using the motion executing unit with the speech output by the speech output unit.

### BRIEF DESCRIPTION OF THE DRAWINGS

FIG. 1 is a block diagram illustrating a system for synchronizing a speech and a motion of a character according to an aspect.

FIG. 2 is a block diagram illustrating a system for synchronizing a speech and a motion of a character, to which a synthesizing unit configured to generate a character animation is added, according to another aspect.

FIG. 3 is a flowchart showing a procedure of synchronizing a speech and a character motion using a system for synchronizing a speech and a motion of a character according to an embodiment.

FIG. 4 is a flowchart showing a procedure, which is performed by a system for synchronizing a speech and a motion of a character according to another embodiment, of generating a speech and an image in advance before synchronization, modifying the speech and image generated through the synchronization, and outputting the modified speech and the modified image.

### DETAILED DESCRIPTION OF EXEMPLARY EMBODIMENTS

The above and other aspects of the present invention will be embodied from the following detailed description of exemplary embodiments taken in conjunction with the accompanying drawings. It should be understood that the components of each embodiment may be variously combined within the embodiment unless otherwise mentioned or mutually contradicted. Each block of the block diagram may refer to a physical component in some cases, but, in other cases, refer to a logical representation of a partial function of one physical component or functions over a plurality of physical components. Sometimes the entity of a block or part thereof may be a set of program instructions. Some or all of these blocks may be implemented by hardware, software, or a combination thereof.

In communication between people, not only a speech but also a gesture serves as a significantly important element. Accordingly, when a person talks with another person, the person may use not only a speech but also a gesture that matches with the speech so that the person may clearly express his or her intention. The gesture plays an important role in complementing or emphasizing human language.

Even in a virtual character communicating with a human, both a speech and a motion of the character are as important as those in person-to-person communication. Matching the contents of the speech with the motion of the character is important, but synchronizing the speech and the motion of the character is also important.

For example, a person may make a gesture of drawing a heart shape while saying “saranghae”. In this case, the person may start to draw the heart shape with a pronunciation of “sa” and finish drawing the heart shape with a pronunciation of “hae.” Alternatively, the person may make a gesture of drawing a heart shape after saying “saranghae.” Alternatively, the person may very slowly make a gesture of drawing a heart shape while also slowly saying “saranghae” to correspond to the gesture of drawing. As such, synchronizing an utterance with a gesture may be implemented in various forms.

In synchronizing a speech and a motion for a given sentence uttered by a character as in human communication, when various forms of synchronization are able to be performed, the character may achieve effective communication.

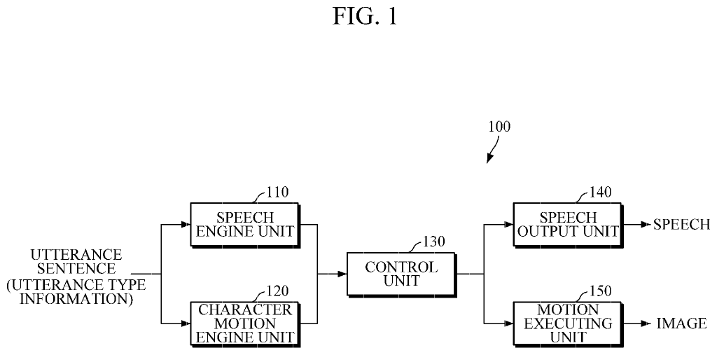

FIG. 1 is a block diagram illustrating a system for synchronizing a speech and a motion of a character according to an aspect. According to the aspect, the system for synchronizing a speech and a motion of a character includes a speech engine unit 110, a character motion engine unit 120, a control unit 130, a motion executing unit 150, and a speech output unit 140.

The system for synchronizing a speech and a motion of a character 100 may be configured as a computing device or a plurality of computing devices having input/output devices. The input device may be a keyboard for inputting a text and may be a microphone device when receiving a speech as an input. The output device may be a speaker for outputting a speech and a display device for outputting an image. The computing device is a device having a memory, a central processing unit (CPU), and a storage device. The system for synchronizing a speech and a motion of a character 100 may be applied to a robot. In particular, when the robot, to which the system for synchronizing a speech and a motion of a character 100 is applied, is a humanoid robot, a speech may be synchronized with a motion of the robot instead of an output image.

The speech engine unit 110 may be a set of program instructions to be executed by the CPU of the computing device. The speech engine unit 110 generates reproduction time information of a speech from an input utterance sentence. The utterance sentence is a text to be converted into a speech. The utterance sentence is previously generated and stored to respond to a sentence input by a user typing in real time through a keyboard input device or a speech input by a user speaking through a microphone input device. That is, the utterance sentence is a character's response to a content that is typed or spoken by a user. The utterance sentence depending on a situation may be selected through a model that is trained using an artificial neural network.

The speech engine unit 110 may be a model that is trained through an artificial neural network algorithm to generate reproduction time information of a speech in units of pronunciation using a large number of utterance sentences as input data. Accordingly, the speech engine unit 110 generates reproduction time information of a speech in units of pronunciation from an input utterance sentence using the artificial neural network algorithm. According to aspects of the present invention, the speech engine unit 110 may generate a temporary speech file to facilitate generation of reproduction time information of a speech.

The speech engine unit 110 may receive utterance type information in addition to the utterance sentence. The utterance type information may include at least one of emphasis information indicating a part to be emphasized in the utterance sentence and an extent of the emphasis, stress information of a syllable, and length information of a syllable. The utterance type information may include information indicating specific information that is a type of information applied only to a speech. The part to be emphasized in the emphasis information may be a syntactic word, a word, or a character indicated to be pronounced with emphasis, and the extent of emphasis may be expressed by a numerical value. For example, the emphasis information may include a word to be emphasized in an utterance sentence and the extent of the emphasis expressed in a numerical value. The stress information is information indicating a syllable to be pronounced strongly and a syllable to be pronounced weakly, and the length information is information indicating a syllable pronounced long and a syllable to be pronounced short. The speech engine unit 110 having received the utterance type information generates reproduction time information of a speech from the utterance sentence using the utterance type information. For example, the speech engine unit 110 may generate the reproduction time information of the speech from the utterance sentence using the utterance type information by temporarily generating reproduction time information of the speech from the utterance sentence and then correcting the generated reproduction time information of the speech to form final reproduction time information of the speech on the basis of the utterance type information. As another example, the speech engine unit 110 may be trained through an artificial neural network algorithm to generate reproduction time information of a speech in units of pronunciation using the utterance sentence and the utterance type information as input data such that reproduction time information of a speech in units of pronunciation is generated through the artificial neural network algorithm using input utterance sentence and utterance type information.

According to some aspects of the present invention, the speech engine unit 110 may generate and transmit speech data for the utterance sentence. In this case, the speech output unit 140, which will be described below, may modify the generated speech data according to reproduction time information of the speech synchronized with execution time information of the character motion.

The character motion engine unit 120 generates motion information of a character corresponding to an input utterance sentence and execution time information of a motion from the input utterance sentence.

The character motion engine unit 120 may be a set of program instructions to be executed by the CPU of the computing device. The character motion engine unit 120 generates motion information of a character corresponding to the input utterance sentence and execution time information of a motion from the utterance sentence. The utterance sentence is a text to be converted into a speech and is used by the character motion engine unit 120 to generate a character motion to be synchronized with the speech. The utterance sentence may be previously generated and stored to respond to a sentence input by a user typing in real time through a keyboard input device or a speech input by a user speaking through a microphone input device and may be input in the form of a voice file of the utterance sentence pronounced. That is, the utterance sentence is a character's response to a content typed or spoken by a user. The utterance sentence depending on a situation may be selected through a model that is learning using an artificial neural network.

The character motion engine unit 120 may be a model that is trained through an artificial neural network algorithm to generate information about a character motion corresponding to each sentence, each syntactic word, or each word using a large number of utterance sentences as input data and to generate execution time information of a motion mapping each syllable in an utterance sentence. Accordingly, the character motion engine unit 120 generates information about a motion of a character corresponding to each sentence, each syntactic word, or each word from an input utterance sentence using an artificial neural algorithm. In this case, the character motion engine unit 120 may generate the character motion information not only for a syntactic word or word included in the utterance sentence but also for a space between the syntactic words. The character motion engine unit 120 may generate a plurality of pieces of character motion information according to an utterance sentence and may generate execution time information of each motion.

For example, the character motion engine unit 120 may generate motion information about drawing a heart shape when an utterance sentence “saranghae” is input and generate execution time information of the motion in which an execution start time of the motion is mapped to a syllable of “sa,” and an execution ending time of the motion is mapped to a syllable of “hae.”

The execution time information of the motion generated by the character motion engine unit 120 may include a minimum execution time and a maximum execution time of the motion.

The character motion engine unit 120 may receive utterance type information in addition to the utterance sentence. The utterance type information may include at least one of emphasis information indicating a part to be emphasized in the utterance sentence and an extent of the emphasis, stress information of a syllable, and length information of a syllable. The part to be emphasized in the emphasis information is a syntactic word, a word or a character to be expressed with emphasis, and the extent of the emphasis may be expressed by a numerical value. For example, the emphasis information may include a word to be emphasized in an utterance sentence and the extent of the emphasis expressed in a numerical value. The stress information is information indicating a syntactic word or a character to be expressed strongly and a syntactic word or a word to be expressed weakly, and the length information is information indicating a syntactic word or a word to be expressed long (i.e., slow) and a syntactic word or a word to be expressed short (i.e., fast). Among the pieces of utterance type information, information marked as an utterance type that is applied only to a speech is not used by the character motion engine unit 120. The character motion engine unit 120 having received the utterance type information generates execution time information of a motion from the utterance sentence using the utterance type information. For example, the character motion engine unit 120 may generate execution time information of a motion by temporarily generating execution time information of the motion from the utterance sentence and then correcting the generated execution time information to form final execution time information of the motion on the basis of the utterance type information. As another example, the character motion engine unit 120 may generate information about a motion of a character corresponding to each sentence, each syntactic word, or each word from an input utterance sentence and utterance type information and generate execution time information of the motion mapped to each syllable in the utterance sentence by using an artificial neural network algorithm that is trained to generate information about a motion of a character corresponding to each sentence, each syntactic word, or each word using an input utterance sentence and utterance type information as input data and to generate execution time information of the motion mapped to each syllable in the utterance sentence.

According to some aspects of the present invention, the character motion engine unit 120 may generate operation information of a character skeleton for executing a motion of a character corresponding to an utterance sentence and transmit the generated operation information to the motion executing unit 150. In this case, the motion executing unit 150, which will be described below, modifies the generated operation information of the character skeleton according to modified execution time information of the character motion and renders the character together with a background and the like on the basis of the modified operation information to generate and output an image. The character skeleton is information used to render an appearance of a character when generating an image frame, and the operation information of the character skeleton has a basic form of an operation of the character to be rendered.

The control unit 130 may be a set of program instructions executed by the CPU of the computing device. The control unit 130 receives the reproduction time information of the speech generated from the speech engine unit 110 and receives the motion information and the execution time information of the motion from the character motion engine unit 120. In addition, the control unit 130 also receives the input utterance sentence through the speech engine unit 110 or the character motion engine unit 120.

The control unit 130 first modifies the execution time information of the motion on the basis of the utterance sentence, the reproduction time information of the speech, and the execution time information of the motion. In order to synchronize the reproduction time information of the speech and the execution time information of the motion, which are independently generated from the utterance sentence, the control unit 130 modifies the execution time information of the motion on the basis of the reproduction time information of the speech. For example, when utterance type information that allows only the speech to be pronounced long is input so that the utterance type information mismatches with the execution time of the motion, the control unit 130 modifies the execution time information of the motion in a range not exceeding the maximum execution time of the motion. Then, the control unit 130 performs synchronization on the reproduction time information of the speech on the basis of the modified execution time information of the motion to generate modified reproduction time information of the speech. In this case, the modifying of the speech may be achieved using a modification method of lengthening or shortening a pronunciation time of a syllable or a modification method of increasing or decreasing an interval between the syllables. Alternatively, when matching the execution time of the motion and the reproduction time of the speech causes severe distortion to the speech due to significantly long length of the execution of the motion, the reproduction time of the speech may be changed such that execution of the motion starts first such that reproduction of the speech starts in the middle of the motion.

The motion executing unit 150 may be a set of program instructions to be executed by the CPU of the computing device. The motion executing unit 150 generates an image in which the motion of the character is executed on the basis of the motion information of the character and the modified execution time information of the motions that are provided by the control unit 130. When the system for synchronizing a speech and a motion of a character 100 is applied to a humanoid robot, the system for synchronizing a speech and a motion of a character 100 may allow the robot to move on the basis of the motion information of the character and the modified execution time information of the motion. According to another aspect of the present invention, the character motion engine unit 120 may generate operation information of a character skeleton for executing a motion of a character, and the motion executing unit 150 may receive the operation information of the character skeleton, modify the received operation information of the character skeleton using the motion information of the character and the modified execution time information of the motion, and generate and reproduce an image on the basis of the modified operation information of the character skeleton.

The speech output unit 140 may be a set of program instructions to be executed by the CPU of the computing device. The speech output unit 140 generates and reproduces a speech according to the modified reproduction time information of the speech provided by the control unit 130. According to another aspect of the present invention, the speech engine unit 110 may generate speech data, and the speech output unit 140 receives the speech data and reproduces a speech modified using the modified reproduction time information of the speech.

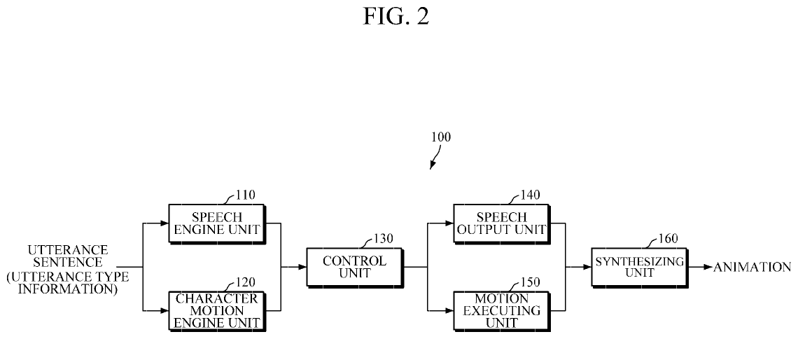

FIG. 2 is a block diagram illustrating a system for synchronizing a speech and a motion of a character, to which a synthesizing unit 160 configured to generate a character animation is added, according to another aspect. According to the aspect, the system for synchronizing a speech and a motion of a character may include the speech engine unit 110, the character motion engine unit 120, the control unit 130, the motion executing unit 150, and the speech output unit 140, and further include the synthesizing unit 160.

The synthesizing unit 160 added according to the aspect is configured to generate a character animation by synthesizing an image output by the motion executing unit 150 with a speech output by the speech output unit 140. The generated character animation may be written in the form of a file and may be stored in a storage device or transmitted to the outside.

According to some aspects of the present invention, the motion executing unit 150 may provide only the operation information of the character skeleton for executing the motion of the character, and the synthesizing unit 160 may generate a character animation by rendering the actual character's appearance, background information and the like.

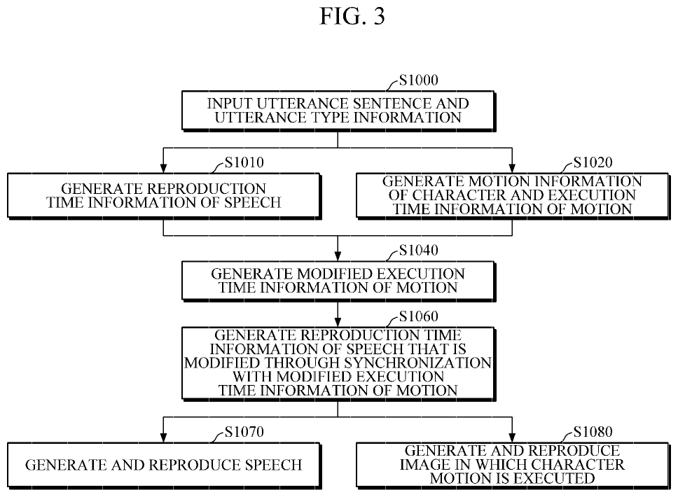

FIG. 3 is a flowchart showing a procedure of synchronizing a speech and a character motion using a system for synchronizing a speech and a motion of a character according to an embodiment. Referring to FIG. 3, the system for synchronizing a speech and a motion of a character 100 receives an utterance sentence and utterance type information and transmits the received utterance sentence and utterance type information to the speech engine unit 110 and the character motion engine unit 120 (S1000), the speech engine unit 110 generates reproduction time information of a speech on the basis of the input utterance sentence and utterance type information (S1010), and the character motion engine unit 120 generates motion information of a character and execution time information of a motion on the basis of the input utterance sentence and utterance type information (S1020). The generated reproduction time information of the speech, the generated motion information of the character, and the generated execution time information of the motion are transmitted to the control unit 130, and the control unit 130 generates modified execution time information of the motion on the basis of the reproduction time information of the speech, the motion information of the character, and the execution time information of the motion (S1040). The control unit 130 generates reproduction time information of the speech that is modified through synchronization with the modified execution time information of the motion (S1060). The speech output unit 140 generates a speech modified according to the modified reproduction time information of the speech and reproduces the generated speech (S1070), and the motion executing unit 150 generates an image, in which a character motion modified according to the motion information of the character and the modified execution time information of the character motion is executed and reproduces the generated image (1080).

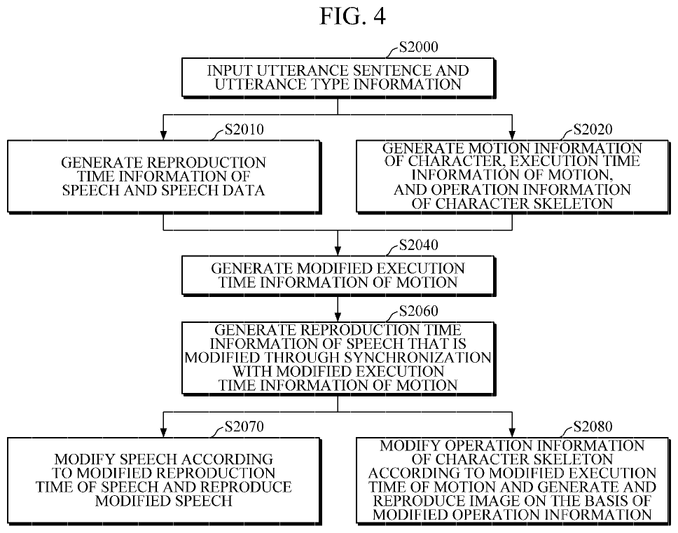

FIG. 4 is a flowchart showing a procedure, which is performed by a system for synchronizing a speech and a motion of a character according to another embodiment, of generating a speech and an image in advance before synchronization, modifying the speech and image generated through the synchronization, and outputting the modified speech and image. Referring to FIG. 4, the system for synchronizing a speech and a motion of a character 100 receives an utterance sentence and utterance type information and transmits the received utterance sentence and utterance type information to the speech engine unit 110 and the character motion engine unit 120 (S2000), and the speech engine unit 110 generates reproduction time information of a speech and speech data on the basis of the input utterance sentence and utterance type information (S2010), and the character motion engine unit 120 generates motion information of a character, execution time information of a motion, and operation information of a character skeleton for executing the motion of the character on the basis of the input utterance sentence and utterance type information (S2020). The generated reproduction time information of the speech, the generated motion information of the character, and the generated execution time information of the motion are transmitted to the control unit 130, and the control unit 130 generates execution time information of the motion modified on the basis of the reproduction time information of the speech, the motion information of the character, and the execution time information of the motion (S2040), and generates reproduction time information of the speech modified through synchronization on the basis of the modified execution time information of the motion (S2060). The speech output unit 140 modifies a speech generated by the speech engine unit 110 according to the modified reproduction time information of the speech and reproduces the modified speech (S2070), and the motion executing unit 150 modifies the operation information of the character skeleton generated by the character motion engine unit 120 according to the motion information of the character and the modified execution time information of the character motion, and generates and reproduces an image on the basis of the modified operation information (S2080).

As is apparent from the above, the system for synchronizing a speech and a motion of a character can output a speech, which is modified by synchronizing a speech and a character motion generated from an utterance sentence on the basis of a time required for executing the character motion of the character together with the character motion.

The system for synchronizing a speech and a motion of a character can output variously expressed speeches and character motions depending on a situation by supporting various modifications for synchronizing a speech and a character motion generated from an utterance sentence.

Although the present invention has been described by the embodiments with reference to the accompanying drawings, it will be apparent to those skilled in the art that various modifications can be made to the above-described exemplary embodiments of the present invention without departing from the spirit or scope of the invention. Thus, it is intended that the present invention covers all such modifications provided they fall within the scope of the appended claims and their equivalents.

1. A system for synchronizing a speech and a motion of a character, the system comprising:
a speech engine unit configured to generate reproduction time information of a speech from an utterance sentence that is input;
a character motion engine unit configured to generate motion information of a character corresponding to the utterance sentence and execution time information of a motion from the utterance sentence that is input;
a control unit configured to generate execution time information of the motion that is modified on the basis of the utterance sentence and the time information regarding the speech, the motion, and reproduction time information of the speech that is modified through synchronization with the modified execution time information of the motion;
a motion executing unit configured to generate an image in which the motion of the character is executed according to the motion information of the character and the modified execution time information of the motion that are provided by the control unit and reproduce the generated image; and
a speech output unit configured to generate a speech according to the modified reproduction time information of the speech that is provided by the control unit and reproduce the generated speech.

2. The system of claim 1, wherein utterance type information is further input to the speech engine unit and the character motion engine unit,
the utterance type information includes at least one of emphasis information indicating a part to be emphasized in the utterance sentence and an extent of the emphasis, stress information of a syllable, and length information of a syllable,
the speech engine unit generates the reproduction time information of the speech from the utterance sentence using the utterance type information, and
the character motion engine unit generates the motion information of the character corresponding to the utterance sentence and the execution time information of the motion from the utterance sentence using the utterance type information.

3. The system of claim 1, wherein the character motion engine unit generates a plurality of pieces of character motion information corresponding to one of a syntactic word, a space between syntactic words, or a word included in the utterance sentence and execution time information of each motion.

4. The system of claim 1, wherein the speech engine unit generates and transmits a speech corresponding to the utterance sentence, and
the speech output unit modifies the speech, which is generated by the speech engine unit, according to the modified reproduction time information of the speech that is provided by the control unit and reproduces the modified speech.

5. The system of claim 1, wherein the character motion engine unit generates and transmits operation information of a character skeleton for executing the motion of the character according to the generated motion information of the character and the modified execution time information of the motion, and
the motion executing unit modifies the operation information of the character skeleton, which is generated by the character motion engine unit according to the motion information of the character and the modified execution time information of the motion that are provided by the control unit, to generate an image in which the motion of the character is executed.

6. The system of claim 1, wherein the modification of the reproduction time information of the speech by the control unit includes modifying a pronunciation time of a syllable or modifying an interval between syllables.

7. The system of claim 1, wherein the execution time information of the motion generated by the character motion engine unit includes a minimum execution time and a maximum execution time of the motion, and
the modification of the execution time information of the motion by the control unit includes determining an execution time of the motion according to the reproduction time information of the speech within a range of a minimum execution time to a maximum execution time of the motion.

8. The system of claim 1, further comprising a synthesizing unit configured to generate a character animation by synthesizing the image output using the motion executing unit with the speech output by the speech output unit.

9. The system of claim 2, wherein the speech engine unit generates and transmits a speech corresponding to the utterance sentence, and
the speech output unit modifies the speech, which is generated by the speech engine unit, according to the modified reproduction time information of the speech that is provided by the control unit and reproduces the modified speech.

10. The system of claim 2, wherein the character motion engine unit generates and transmits operation information of a character skeleton for executing the motion of the character according to the generated motion information of the character and the modified execution time information of the motion, and
the motion executing unit modifies the operation information of the character skeleton, which is generated by the character motion engine unit according to the motion information of the character and the modified execution time information of the motion that are provided by the control unit, to generate an image in which the motion of the character is executed.
